(19) United States
(12) Patent Application Publication
(10) Pub. No.: US 2008/0145151 A1
(43) Pub. Date: Jun. 19, 2008

(54) GUIDE APPARATUS TO GUIDE AXIAL PIPE MOVEMENT

(75) Inventor: Guy Rodrigue, Beaumont (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: 1279881 ALBERTA LTD., Nisku, AB (CA)

(21) Appl. No.: 11/675,052

(22) Filed: Feb. 14, 2007

(30) Foreign Application Priority Data
Dec. 14, 2006 (CA) 2570728

(51) Int. Cl. F16L 3/01

(52) U.S. Cl. 405/184.4

(57) ABSTRACT

A guide apparatus to guide axial pipe movement includes a base, a support frame mounted on the base, and rollers supported in a generally “U” shaped configuration by the support frame.

### FIELD

The present invention relates to a guide apparatus which is used to guide pipe moving axially along a ground surface.

### BACKGROUND

Pipes used for pipelines have a coating to protect them from corrosion. When installing pipelines under rivers and other natural or man-made obstacles, lengths of connected pipe are pulled axially along the ground. This subjects the protective coating on the pipe to abrasion. To prevent damage to the coatings, various configurations of guide apparatus are used to guide the axial pipe movement. A common form of guide apparatus uses a “V” configuration roller. Problems have been encountered with the “V” roller, with the pipe climbing up the “V” configuration and falling off the guide apparatus.

### SUMMARY

According to the present invention there is provided a guide apparatus to guide axial pipe movement. The guide apparatus includes a base, a support frame mounted on the base, and rollers supported in a generally “U” shaped configuration by the support frame.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a guide apparatus.

FIG. 2 is a side elevation view of the guide apparatus of FIG. 1.

### DETAILED DESCRIPTION

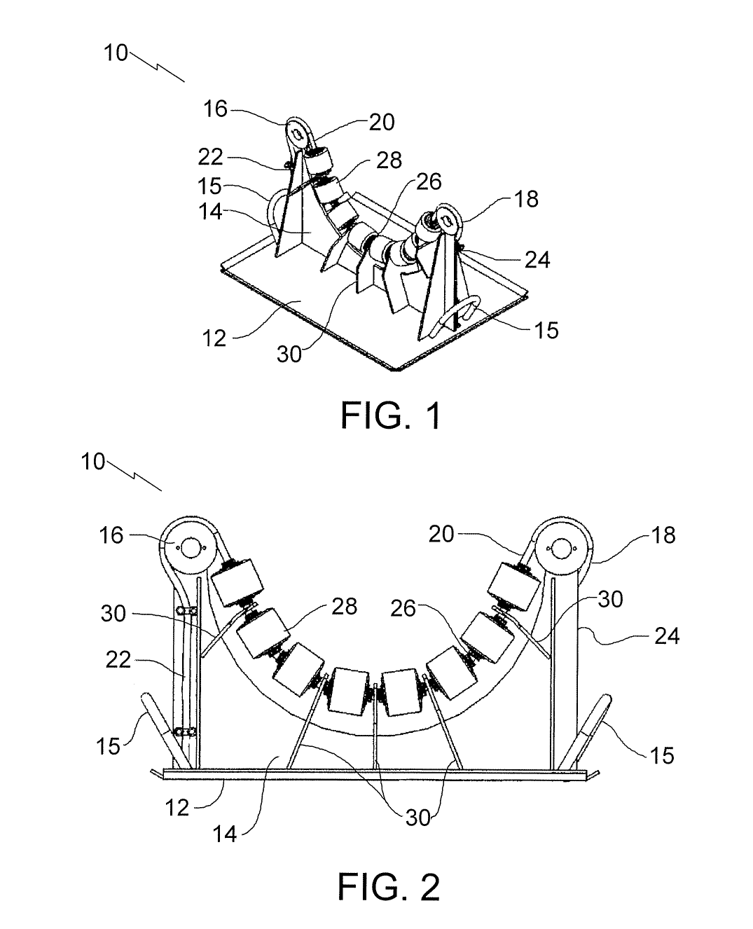

The preferred embodiment, a guide apparatus to guide axial pipe movement generally identified by reference numeral 10, will now be described with reference to FIGS. 1 and 2.

Structure and Relationship of Parts:

Referring to FIG. 1, guide apparatus 10 includes a base 12 and a support frame 14 mounted on base 12. Base 12 may be a skid plate base that is able to slide along a ground surface in response to a lateral force, and has folded edges for self-alignment. Handles 15 may be provided on base 12 to assist in moving apparatus 10. Support frame 14 is generally U-shaped to correspond with the shape of the pipe to be guided. A pair of spaced apart cable guides 16 and 18 are supported by support frame 14. Cable guides 16 and 18 are then used to support a cable 20 that has opposed end portions 22 and 24 anchored to support frame 14. Cable 20 may be otherwise anchored, such as to base 12. Referring to FIG. 2, cable 20 has a pipe supporting portion 26 sagging between cable guides 16 and 18 in a generally “U” shaped configuration. Rollers 28 are mounted on pipe supporting portion 26 of cable 20. Adequate results have been obtained using rollers made from urethane and mounted on bearings. Support members 30 may be used to ensure proper spacing of rollers 28 and to stabilize cable 20. As shown, support members 30 are supported by and project from both base 12 and support frame 14 to engage cable 20 at spaced intervals. It will be understood that support members 30 may be supported by other means as well.

Operation:

Referring to FIGS. 1 and 2, guide apparatus 10 is provided as described above. Referring to FIG. 1, base 12 is positioned in the desired location using handles 15. Referring to FIG. 2, a pipe to be guided is placed on rollers 28 that are mounted on pipe supporting portion 26 of cable 20. Rollers 28 in the U-shaped configuration help maintain pipe within the pipe supporting portion 26 of cable 20. As the pipe is guided, base 12, which is designed as a skid plate, allows the position of guide apparatus 10 to be changed if lateral forces act on it.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A guide apparatus to guide axial pipe movement, comprising:
a base;
a support frame mounted on the base; and
rollers supported in a generally “U” shaped configuration by the support frame.

2. The guide apparatus of claim 1, wherein:
a pair of spaced apart cable guides are supported by the support frame;
a cable is supported by the cable guides, the cable having opposed end portions anchored to one of the base or the support frame with a pipe supporting portion sagging between the cable guides in a generally “U” shaped configuration;
with the rollers mounted on the pipe supporting portion of the cable.

3. The guide apparatus of claim 2, wherein there are roller spacing and cable stabilizing members engaging the cable at spaced intervals along the cable.

4. The guide apparatus of claim 1, wherein at least one handle is provided on the base.

5. The guide apparatus of claim 1, wherein the base is configured as a skid plate which is adapted to slide along a ground surface in response to a lateral force.

6. A guide apparatus to guide axial pipe movement, comprising:
a skid plate base adapted to slide along a ground surface in response to a lateral force;
a support frame mounted on the base;
a pair of spaced apart cable guides supported by the support frame;
a cable supported by the cable guides, the cable having opposed end portions anchored to one of the base or the support frame with a pipe supporting portion sagging between the cable guides in a generally “U” shaped configuration;
rollers mounted on the pipe supporting portion of the cable; and
roller spacing and cable stabilizing members projecting from one of the base or the support frame to engage the cable at spaced intervals.

7. The guide apparatus of claim 6, wherein at least one handle is provided on the base.
